(19) United States
(12) Patent Application Publication
(10) Pub. No.: US 2026/0188749 A1
(43) Pub. Date: Jul. 2, 2026

(54) NON-AQUEOUS ELECTROLYTE, ELECTROCHEMICAL APPARATUS, AND ELECTRONIC APPARATUS

(71) Applicant: Ningde Amperex Technology Limited, Ningde City (CN)

(72) Inventors: Junfei Liu, Ningde City (CN); Yezhen Zheng, Ningde City (CN); Shaoyun Zhou, Ningde City (CN); Chao Tang, Ningde City (CN)

(73) Assignee: Ningde Amperex Technology Limited, Ningde City (CN)

(21) Appl. No.: 19/437,838

(22) Filed: Dec. 31, 2025

(30) Foreign Application Priority Data
Jan. 2, 2025 (CN) 202510005605.8

(51) Int. Cl. H01M 10/0569; H01M 10/0525

(52) U.S. Cl. CPC H01M 10/0569; H01M 10/0525; H01M 2300/0037

(57) ABSTRACT

A non-aqueous electrolyte includes chain carbonates and cyclic carbonates, where the chain carbonates include dimethyl carbonate, ethyl methyl carbonate, and diethyl carbonate, and the cyclic carbonates include at least one of ethylene carbonate and propylene carbonate; and based on a total mass of the non-aqueous electrolyte, a mass percentage of dimethyl carbonate is M₁%, where 0.001≤M₁≤0.1; a mass percentage of ethyl methyl carbonate is M₂%, where 15≤M₂≤60; a mass percentage of diethyl carbonate is M₃%, where 5≤M₃≤35; a mass percentage of ethylene carbonate is M₄%, a mass percentage of propylene carbonate is M₅%, and 20≤M₄+M₅≤40.

### CROSS REFERENCE TO THE RELATED APPLICATIONS

This application claims the benefit of priority from the Chinese Patent Application No. 202510005605.8, filed on Jan. 2, 2025, the entire content of which is incorporated herein by reference.

### TECHNICAL FIELD

The present application relates to the field of energy storage technology, and in particular to, a non-aqueous electrolyte, an electrochemical apparatus, and an electronic apparatus.

### BACKGROUND

As the demand for electronic products increases year by year, lithium-ion batteries, as power sources for electronic products, are playing an increasingly important role in our daily lives. The high-power performance of lithium-ion batteries depends on the transport capacity of lithium ions in the non-aqueous electrolyte. In the prior art, while chain ester compounds are used to improve the dissociation ability of lithium salts in the non-aqueous electrolyte, they often lead to an increase in the viscosity of the non-aqueous electrolyte, which in turn increases the transport resistance of lithium ions. Therefore, it is urgent to provide a lithium-ion battery with high-efficiency battery transport capacity.

### SUMMARY OF THE INVENTION

Some embodiments of the present application provide a non-aqueous electrolyte, an electrochemical apparatus, and an electronic apparatus, which achieve good high-rate discharge performance while also improving high-temperature storage performance.

In a first aspect, an embodiment of the present application provides a non-aqueous electrolyte, the non-aqueous electrolyte including chain carbonates and cyclic carbonates, where the chain carbonates include dimethyl carbonate, ethyl methyl carbonate, and diethyl carbonate, and the cyclic carbonates include at least one of ethylene carbonate and propylene carbonate; and based on a total mass of the non-aqueous electrolyte, a mass percentage of dimethyl carbonate is M₁%, where 0.001 ≤M₁≤0.1; a mass percentage of ethyl methyl carbonate is M₂%, where 15≤M₂≤60; a mass percentage of diethyl carbonate is M₃%, where 5≤M₃≤35; and a mass percentage of ethylene carbonate is M₄%, a mass percentage of propylene carbonate is M₅%, and 20≤M₄+M₅≤40.

Based on the non-aqueous electrolyte of these embodiments of the present application, the inventors have found that when the non-aqueous electrolyte includes the above chain carbonates and cyclic carbonates and the mass percentages of each chain carbonate and cyclic carbonate in the non-aqueous electrolyte are controlled to satisfy the above ranges, the cyclic carbonates can solvate lithium ions to improve the dissociation ability of lithium salts. Chain ester solvents have low viscosity, and a high content of chain carbonates can reduce the migration resistance of solvated lithium ions, thereby improving the transport capacity of lithium ions in the non-aqueous electrolyte. In addition, the specific ratio of chain carbonates can inhibit the continuous occurrence of the transesterification reaction ethyl methyl carbonate→dimethyl carbonate+diethyl carbonate, reduce oxidative decomposition of chain carbonates, enhance their stability, and promote efficient transport of lithium ions in the non-aqueous electrolyte, thereby improving the high-rate discharge performance and high-temperature storage performance of the electrochemical apparatus.

In some embodiments, the non-aqueous electrolyte satisfies at least one of the following conditions:

$$20 \leq {M}_{2} \leq 50 ; \qquad ( 1 )$$

$$40 \leq {M}_{2} + {M}_{3} \leq 66 ; or \qquad ( 2 )$$

$$0.1 \leq \frac{100 \times {M}_{1} + {M}_{3}}{{M}_{2}} \leq 3. \qquad ( 3 )$$

Based on the above embodiments, by adjusting the mass percentage M₂% of ethyl methyl carbonate and its relationship with the mass percentage M₃% of diethyl carbonate and the mass percentage M₁% of dimethyl carbonate to satisfy any of the above conditions, the present application can further improve the stability of chain carbonates while enhancing the dissociation ability of lithium salts, thereby further improving the high-rate discharge performance and high-temperature storage performance of the electrochemical apparatus.

In some embodiments, the non-aqueous electrolyte includes at least one of lithium hexafluorophosphate (LiPF₆) and lithium bis(fluorosulfonyl)imide (LiFSI). Based on the total mass of the non-aqueous electrolyte, a mass percentage of lithium hexafluorophosphate is M₆%, and a mass percentage of lithium bis(fluorosulfonyl)imide is M₇%, where 2.5≤M₆≤25 and 15≤M₆+M₇≤25. Based on the above embodiments, by further adding specific amounts of lithium hexafluorophosphate and lithium bis(fluorosulfonyl)imide to the non-aqueous electrolyte of the present application, since the anion of LiFSI has a large volume and non-concentrated charge density distribution, it has a weak binding with Li⁺, which is more favorable for dissociation and provides higher conductivity, while LiFSI can form an interfacial protective film containing low-impedance components such as Li₃N or Li₂S on the electrode surface, and the synergistic cooperation of the two with the above electrolyte system can further improve the high-rate discharge performance and high-temperature storage performance of the electrochemical apparatus.

In some embodiments, the non-aqueous electrolyte satisfies:

$$2.17 \leq \frac{\frac{{M}_{4}}{86.06} + \frac{{M}_{5}}{102.09}}{\frac{{M}_{6}}{151.91} + \frac{{M}_{7}}{187.07}} \leq 4.85 .$$

Based on the above embodiments, in the present application, by adjusting the relationship between the mass percentage M₄% of ethylene carbonate, the mass percentage M₅% of propylene carbonate, the mass percentage M₆% of lithium hexafluorophosphate, and the mass percentage M₇% of lithium bis(fluorosulfonyl)imide in the non-aqueous electrolyte to satisfy the above range, the high-rate discharge performance and high-temperature storage performance of the electrochemical apparatus can be improved.

In some embodiments, the non-aqueous electrolyte includes vinylene carbonate; based on the total mass of the non-aqueous electrolyte, a mass percentage of vinylene carbonate is E %, where 0.001≤E≤0.05. Based on the above embodiments, when the non-aqueous electrolyte of the present application further includes vinylene carbonate and its mass percentage is within the above range, the organic SEI film formed by reductive polymerization during negative electrode film formation has good stability, can improve the protection of the negative electrode, and can reduce side reactions on the positive electrode, thereby improving the high-rate discharge performance and high-temperature storage performance of the electrochemical apparatus and suppressing volume swelling caused by gas production during overdischarge storage.

In some embodiments, the non-aqueous electrolyte includes a compound of formula I:

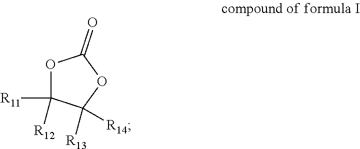

where each of R₁₁, R₁₂, R₁₃ and R₁₄ is independently selected from H, F, C₁ to C₃ alkyl or fluorine-substituted C₁ to C₃ alkyl, and at least one of R₁₁, R₁₂, R₁₃ and R₁₄ is a fluorine atom; and based on the total mass of the non-aqueous electrolyte, a mass percentage of the compound of formula I is a %, where 0.01≤a≤1. In some embodiments, the compound of formula I is at least one selected from the following compounds:

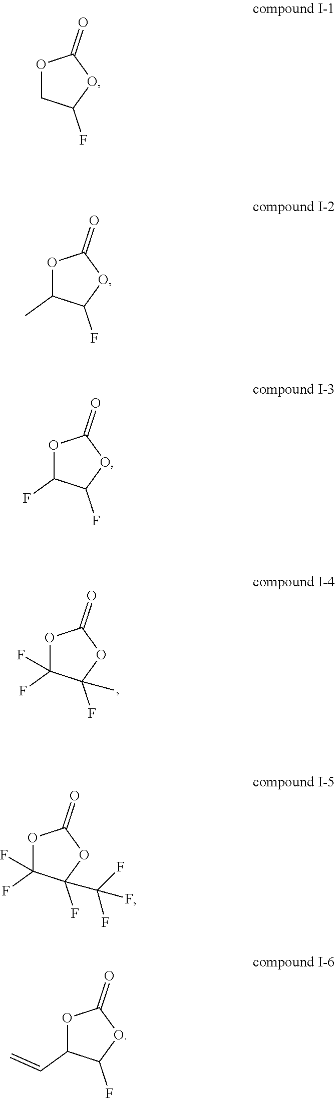

Based on the above embodiments, when the non-aqueous electrolyte of the present application further includes the above compound of formula I and its mass percentage is within the above range, the compound of formula I can participate in reductive film formation on the negative electrode, and the fluorine-containing groups in the structure of the compound of formula I can form LiF during film formation, reducing the impedance of negative electrode SEI film formation and providing a good negative electrode film-forming effect, thereby further improving the high-rate discharge performance and high-temperature storage performance of the electrochemical apparatus and suppressing volume swelling caused by gas production during overdischarge storage.

In some embodiments, the non-aqueous electrolyte includes a compound of formula II:

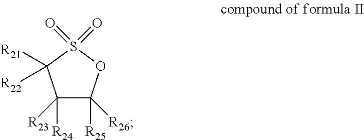

where each of R₂₁, R₂₂, R₂₃, R₂₄, R₂₅ and R₂₆ is independently selected from H, F, C₁ to C₃ alkyl or fluorine-substituted C₁ to C₃ alkyl; and based on the total mass of the non-aqueous electrolyte, a mass percentage of the compound of formula II is b %, where 2≤b≤4. In some embodiments, the compound of formula II includes at least one of the following compounds:

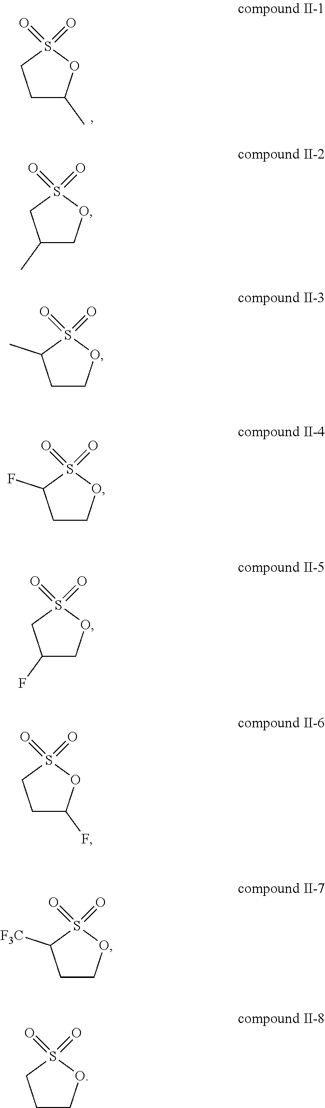

Based on the above embodiments, when the non-aqueous electrolyte of the present application further includes the above compound of formula II and its mass percentage is within the above range, the compound of formula II can enter the lithium ion solvation layer and preferentially form a film on the positive electrode, inhibiting oxidative decomposition of the solvent in the non-aqueous electrolyte on the positive electrode, reducing impedance increase caused by by-products after solvent oxidation, and alleviating gas production in the fully charged state of the cell, thereby further improving the high-rate discharge performance and high-temperature storage performance of the electrochemical apparatus and suppressing volume swelling caused by gas production during overdischarge storage.

In a second aspect, an embodiment of the present application provides an electrochemical apparatus including a positive electrode plate, a negative electrode plate, and the non-aqueous electrolyte described above; the positive electrode plate includes a positive electrode current collector and a positive electrode mixture layer disposed on at least one surface of the positive electrode current collector, and the negative electrode includes a negative electrode current collector and a negative electrode mixture layer disposed on at least one surface of the negative electrode current collector; the positive electrode active material in the positive electrode mixture layer includes LiₓNi_{y}M_{1-y}O_{2-z}A_{z}, where 0.98≤x≤1.1, 0.53≤y≤0.95, and 0<z≤0.05; and based on a total mass of the positive electrode mixture layer, a mass percentage of nickel element is n %, where 33≤n≤56; where element M is at least one selected from aluminum, magnesium, manganese, cobalt, iron, chromium, vanadium, titanium, copper, calcium, zinc, zirconium, niobium, molybdenum, strontium, antimony, tungsten, or bismuth; and element A is at least one selected from fluorine, phosphorus, sulfur, boron, silicon, or chlorine. Based on the above embodiments, the electrochemical apparatus of the present application adopts the positive electrode active material, which can cooperate with the electrolyte to match the lithium ion intercalation/deintercalation rates of the positive and negative electrodes, achieving better charge-discharge performance, thereby further improving the high-rate discharge performance of the electrochemical apparatus while also improving high-temperature storage performance.

In a third aspect, an embodiment of the present application provides an electronic apparatus including the electrochemical apparatus described above.

### DETAILED DESCRIPTION

In order to make the objectives, technical solutions, and advantages of the present application clearer, the present application will be further described in detail below in conjunction with embodiments. It should be understood that the specific embodiments described herein are only used to explain the present application and are not intended to limit the present application.

Some embodiments of the present application provide an electrochemical apparatus including a non-aqueous electrolyte, a positive electrode, a negative electrode, and a separator.

### Non-Aqueous Electrolyte

The non-aqueous electrolyte used in the electrochemical apparatus of these embodiments of the present application includes an electrolyte and a solvent that dissolves the electrolyte. In some embodiments, the non-aqueous electrolyte includes chain carbonates and cyclic carbonates, the chain carbonates include dimethyl carbonate, ethyl methyl carbonate, and diethyl carbonate, and the cyclic carbonates include at least one of ethylene carbonate and propylene carbonate. In some of these embodiments, based on a total mass of the non-aqueous electrolyte, a mass percentage of dimethyl carbonate is M₁%, where 0.001≤M₁≤0.1. For example, M₁ may be 0.001, 0.004, 0.01, 0.03, 0.07, 0.1, or any value in the range consisting of any two of these values. The mass percentage of ethyl methyl carbonate is M₂%, where 15≤M₂≤60, preferably 20≤M₂≤50. For example, M₂ may be 15, 20, 21, 32, 38, 45, 50, 58, 60, or any value in the range consisting of any two of these values. The mass percentage of diethyl carbonate is M₃%, where 5≤M₃≤35. For example, M₃ may be 5, 6, 16, 27, 30, 35, or any value in the range consisting of any two of these values. 40≤M₂+M₃≤66, for example, the sum of the mass percentage M₂% of ethyl methyl carbonate and the mass percentage M₃% of diethyl carbonate may be 40, 46, 52, 59, 60, 63, 66, or any value in the range consisting of any two of these values. In some embodiments,

$$0.1 \leq \frac{100 \times {M}_{1} + {M}_{3}}{{M}_{2}} \leq 3.$$

In some embodiments,

$$0.2 \leq \frac{100 \times {M}_{1} + {M}_{3}}{{M}_{2}} 0.8 .$$

In some embodiments,

$$0.5 \leq \frac{100 \times {M}_{1} + {M}_{3}}{{M}_{2}} 2.6 .$$

In some embodiments,

$$0.4 \leq \frac{100 \times {M}_{1} + {M}_{3}}{{M}_{2}} \leq 1.7 .$$

A mass percentage of ethylene carbonate is M₄%, a mass percentage of propylene carbonate is M₅%, and 20≤M₄+M₅≤40. For example, M₄+M₅ may be 20, 25, 28, 32, 36, 40, or any value in the range consisting of any two of these values. When the non-aqueous electrolyte includes the above chain carbonates and cyclic carbonates and the mass percentages of each chain carbonate and cyclic carbonate in the non-aqueous electrolyte are controlled to satisfy the above ranges, efficient transport of lithium ions in the non-aqueous electrolyte can be promoted, improving the high-rate discharge performance and high-temperature storage performance of the electrochemical apparatus.

In some embodiments, the non-aqueous electrolyte includes at least one of lithium hexafluorophosphate and lithium bis(fluorosulfonyl)imide; and based on the total mass of the non-aqueous electrolyte, a mass percentage of lithium hexafluorophosphate is M₆%, and a mass of lithium bis(fluorosulfonyl)imide is M₇%, where 2.5≤M₆≤25 and 15≤M₆+M₇≤25. For example, M₆ may be 2.5, 6.8, 10, 14, 23, 25, or any value in the range consisting of any two of these values. M₆+M₇ may be 15, 16, 18, 22, 24, 25, or any value in the range consisting of any two of these values. The non-aqueous electrolyte further including specific amounts of lithium hexafluorophosphate and lithium bis(fluorosulfonyl)imide can further improve the high-rate discharge performance and high-temperature storage performance of the electrochemical apparatus.

In some embodiments, the non-aqueous electrolyte satisfies

$$2.17 \leq \frac{\frac{{M}_{4}}{86.06} + \frac{{M}_{5}}{102.09}}{\frac{{M}_{6}}{151.91} + \frac{{M}_{7}}{187.07}} \leq 4.85 .$$

In some embodiments,

$$2.6 \leq \frac{\frac{{M}_{4}}{86.06} + \frac{{M}_{5}}{102.09}}{\frac{{M}_{6}}{151.91} + \frac{{M}_{7}}{187.07}} \leq 4.2 .$$

In some embodiments,

$$3.4 \leq \frac{\frac{{M}_{4}}{86.06} + \frac{{M}_{5}}{102.09}}{\frac{{M}_{6}}{151.91} + \frac{{M}_{7}}{187.07}} \leq 3.9 .$$

In some embodiments,

$$2.4 \leq \frac{\frac{{M}_{4}}{86.06} + \frac{{M}_{5}}{102.09}}{\frac{{M}_{6}}{151.91} + \frac{{M}_{7}}{187.07}} \leq 4.8 .$$

When the relationship between the mass percentage of ethylene carbonate, the mass percentage of propylene carbonate, the mass percentage of lithium hexafluorophosphate, and the mass percentage of lithium bis(fluorosulfonyl)imide in the non-aqueous electrolyte satisfies the above range, the high-rate discharge performance and high-temperature storage performance of the electrochemical apparatus can be further improved.

In some embodiments, the non-aqueous electrolyte includes vinylene carbonate. Based on the total mass of the non-aqueous electrolyte, a mass percentage of vinylene carbonate is E %, where 0.001≤E≤0.05. For example, E may be 0.001, 0.008, 0.015, 0.029, 0.041, 0.05, or any value in the range consisting of any two of these values. When the non-aqueous electrolyte further includes vinylene carbonate and its mass percentage is within the above range, the protection of the negative electrode can be improved, and side reactions on the positive electrode can be reduced, thereby improving the high-rate discharge performance and high-temperature storage performance of the electrochemical apparatus while suppressing volume swelling caused by gas production during overdischarge storage.

In some embodiments, the non-aqueous electrolyte includes a compound of formula I:

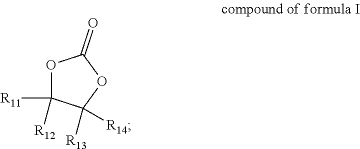

where each of R₁₁, R₁₂, R₁₃ and R₁₄ is independently selected from H, F, C₁ to C₃ alkyl or fluorine-substituted C₁ to C₃ alkyl, and at least one of R₁₁, R₁₂, R₁₃ and R₁₄ is a fluorine atom; and based on the total mass of the non-aqueous electrolyte, a mass percentage of the compound of formula I is a %, where 0.01≤a≤1. For example, a may be 0.01, 0.19, 0.34, 0.46, 0.82, 1, or any value in the range consisting of any two of these values. In some embodiments, the compound of formula I is at least one selected from the following compounds:

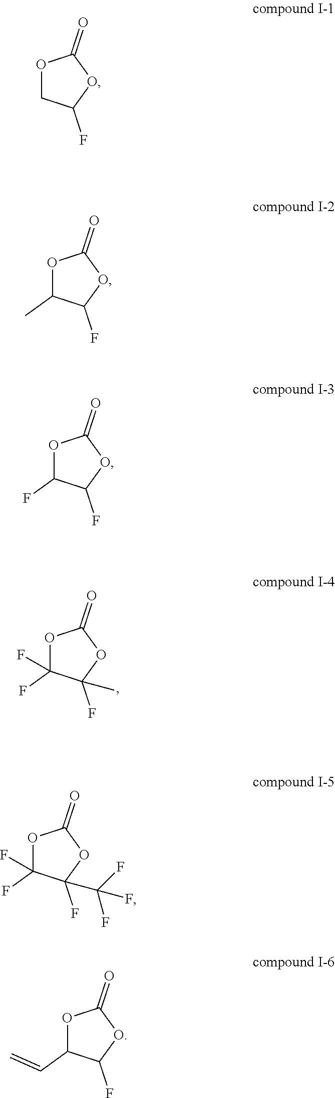

When the non-aqueous electrolyte further includes the compound of formula I and its mass percentage is within the above range, it has a good negative electrode film-forming effect, thereby further improving the high-rate discharge performance and high-temperature storage performance of the electrochemical apparatus while suppressing volume swelling caused by gas production during overdischarge storage.

In some embodiments, the non-aqueous electrolyte includes a compound of formula II:

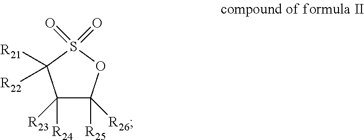

where each of R₂₁, R₂₂, R₂₃, R₂₄, R₂₅ and R₂₆ is independently selected from H, F, C₁ to C₃ alkyl or fluorine-substituted C₁ to C₃ alkyl; and based on the total mass of the non-aqueous electrolyte, a mass percentage of the compound of formula II is b %, where 2≤b≤4. For example, b may be 2, 2.3, 2.6, 3.3, 3.8, 4, or any value in the range consisting of any two of these values. In some embodiments, the compound of formula II includes at least one of the following compounds:

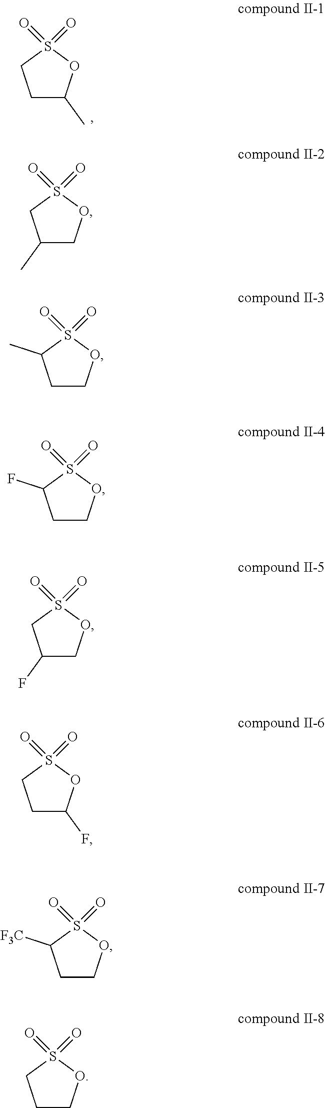

When the non-aqueous electrolyte further includes the above compound of formula II, oxidative decomposition of the solvent in the non-aqueous electrolyte on the positive electrode can be further suppressed, and the influence of HF generated from oxidative decomposition of vinylene carbonate on the positive electrode and decomposition of the compound of formula I itself on the positive electrode can be reduced, thereby further improving the high-rate discharge performance and high-temperature storage performance of the electrochemical apparatus while suppressing volume swelling caused by gas production during overdischarge storage.

The non-aqueous electrolyte may also include other non-aqueous solvents. The present application has no particular limitation on the type of the above other non-aqueous solvents as long as the objectives of the present application can be achieved, and may include, for example but is not limited to, at least one of other carbonate compounds, carboxylic ester compounds, ether compounds, or other organic solvents. The above carbonate compounds may include, but are not limited to, at least one of other chain carbonate compounds or other cyclic carbonate compounds.

The above other chain carbonate compounds may include, but are not limited to, at least one of dipropyl carbonate, methyl propyl carbonate, or ethyl propyl carbonate. The above other cyclic carbonate compounds may include, but are not limited to, at least one of butylene carbonate or vinylethylene carbonate.

The above carboxylic ester compounds may include, but are not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone.

The above ether compounds may include, but are not limited to, at least one of ethylene glycol dimethyl ether, dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran.

The above other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

### Positive Electrode

The positive electrode includes a positive electrode current collector and a positive electrode mixture layer disposed on at least one surface of the positive electrode current collector. A positive electrode active material in the positive electrode mixture layer includes LiₓNi_{y}M_{1-y}O_{2-z}A_{z}, where 0.98≤x≤1.1, 0.53≤y≤0.95, and 0<z≤0.05. Based on a total mass of the positive electrode mixture layer, a mass percentage of nickel element is n %, satisfying 33≤n≤56. For example, n may be 33, 34, 38, 40, 46, 48, 52, 56, or any value in the range consisting of any two of these values. Element M is at least one selected from aluminum, magnesium, manganese, cobalt, iron, chromium, vanadium, titanium, copper, calcium, zinc, zirconium, niobium, molybdenum, strontium, antimony, tungsten, or bismuth; and element A is at least one selected from fluorine, phosphorus, sulfur, boron, silicon, or chlorine. The electrochemical apparatus adopting the above positive electrode active material can cooperate with the non-aqueous s electrolyte to match the lithium ion intercalation/deintercalation rates of the positive and negative electrodes, achieving better charge-discharge performance, thereby further improving the high-rate discharge performance and high-temperature storage performance of the electrochemical apparatus.

In some embodiments, the positive electrode material layer includes a positive electrode conductive material; there is no limitation on the type of the positive electrode conductive material, and any known conductive material may be used. Examples of the positive electrode conductive material may include, but are not limited to, carbon black such as acetylene black and Super-P; amorphous carbon such as needle coke; carbon nanotubes; and graphene. The above positive electrode conductive materials may be used alone or in any combination.

In some embodiments, the positive electrode material layer includes a positive electrode binder; there is no particular limitation on the type of the positive electrode binder, and in the case of a coating method, any material that is soluble or dispersible in the liquid medium used in electrode manufacturing may be used. Examples of the positive electrode binder may include, but are not limited to, one or more of the following: resins such as polyethylene, polypropylene, polyethylene terephthalate, polymethyl methacrylate, polyimide, aromatic polyamide, cellulose, and nitrocellulose; rubbery polymers such as styrene-butadiene rubber, nitrile rubber, fluororubber, isoprene rubber, polybutadiene rubber, and ethylene-propylene rubber; thermoplastic elastomeric polymers such as styrene-butadiene-styrene block copolymers or hydrogenated products thereof, ethylene-propylene-diene terpolymers, styrene-ethylene-butadiene-ethylene copolymers, and styrene-isoprene-styrene block copolymers or hydrogenated products thereof; soft resinous polymers such as syndiotactic-1,2-polybutadiene, polyvinyl acetate, ethylene-vinyl acetate copolymers, and propylene-α-olefin copolymers; fluoropolymers such as polyvinylidene fluoride, polytetrafluoroethylene, fluorinated polyvinylidene fluoride, and polytetrafluoroethylene-ethylene copolymers; and polymer compositions having ionic conductivity of alkali metal ions. The above positive electrode binders may be used alone or in any combination.

There is no limitation on the type of solvent used to form the positive electrode slurry, as long as it can dissolve or disperse the positive electrode active substance, conductive material, positive electrode binder, and thickener used as needed. Examples of the solvent used to form the positive electrode slurry may include any of aqueous solvents and organic solvents. Examples of aqueous media may include, but are not limited to, mixed media of alcohol and water, or water. Examples of organic media may include, but are not limited to, aliphatic hydrocarbons such as hexane; aromatic hydrocarbons such as benzene, toluene, xylene, and methylnaphthalene; heterocyclic compounds such as quinoline and pyridine; ketones such as acetone, methyl ethyl ketone, and cyclohexanone; esters such as methyl acetate and methyl acrylate; amines such as diethylenetriamine and N,N-dimethylaminopropylamine; ethers such as diethyl ether, propylene oxide, and tetrahydrofuran; amides such as N-methylpyrrolidone, dimethylformamide, and dimethylacetamide; and aprotic polar solvents such as hexamethylphosphoramide and dimethyl sulfoxide.

Thickeners are generally used to adjust the viscosity of the slurry. In the case of using an aqueous medium, a thickener and a styrene-butadiene rubber emulsion may be used for applying a slurry. There is no particular limitation on the type of thickener, and examples thereof may include, but are not limited to, carboxymethyl cellulose, methyl cellulose, hydroxymethyl cellulose, ethyl cellulose, polyvinyl alcohol, oxidized starch, phosphorylated starch, casein, and salts thereof. The above thickeners may be used alone or in any combination.

There is no particular limitation on the type of positive electrode current collector, and any material known to be suitable for use as a positive electrode current collector may be used. Examples of the positive electrode current collector may include, but are not limited to, metal materials such as aluminum, stainless steel, nickel plating, titanium, and tantalum; and materials such as carbon cloth and carbon paper. In some embodiments, the positive electrode current collector is a metal material. In some embodiments, the positive electrode current collector is aluminum.

In order to reduce the electronic contact resistance between the positive electrode current collector and the positive electrode material layer, the surface of the positive electrode current collector may include a conductive aid or a conductive coating. Examples of the conductive aid may include, but are not limited to, carbon and noble metals such as gold, platinum, and silver. Examples of the conductive coating may include a mixed layer containing an inorganic oxide, a conductive agent, and a binder.

### Negative Electrode

The negative electrode includes a negative electrode current collector and a negative electrode material layer disposed on at least one surface of the negative electrode current collector, and the negative electrode material layer includes a negative electrode active substance. In some embodiments, the chargeable capacity of the negative electrode active substance is greater than the discharge capacity of the positive electrode active substance to prevent unintentional precipitation of lithium metal on the negative electrode during charging.

The negative electrode active substance may include at least one of natural graphite, artificial graphite, mesocarbon microbeads (MCMB), silicon, silicon-carbon composite, SiO_{w} (0.5<w<1.6), Li—Sn alloy, Li—Sn—O alloy, Sn, SnO, SnO₂, spinel-structured lithium titanate Li₄Ti₅O₁₂, Li—Al alloy, or metallic lithium. Optionally, the negative electrode active substance may further include an amorphous carbon material, and the amorphous carbon may be soft carbon (low-temperature calcined carbon), hard carbon, mesophase pitch carbide, calcined coke, or the like.

The negative electrode material layer of the present application further includes a negative electrode binder. The negative electrode binder can improve the binding between negative electrode active material particles and the binding between the negative electrode active material and the current collector. There is no particular limitation on the type of the negative electrode binder, as long as it is a material stable to the electrolyte or the solvent used in electrode manufacturing. In some embodiments, the negative electrode binder includes a resin binder. Examples of the resin binder include, but are not limited to, fluororesin, polyacrylonitrile (PAN), polyimide resin, acrylic resin, and polyolefin resin. When an aqueous solvent is used to prepare the negative electrode binder slurry, the negative electrode binder includes, but is not limited to, carboxymethyl cellulose (CMC) or a salt thereof, styrene-butadiene rubber (SBR), polyacrylic acid (PAA) or a salt thereof, and polyvinyl alcohol.

The negative electrode material layer of the present application further includes a conductive agent. There is no particular limitation on the type of the negative electrode conductive agent in the present application, as long as the objectives of the present application can be achieved. For example, the negative electrode conductive agent may be at least one of acetylene black, Ketjen black, carbon nanotubes, carbon fibers, carbon dots, or graphene, and the above carbon nanotubes may include, but are not limited to, at least one of single-walled carbon nanotubes or multi-walled carbon nanotubes.

There is no particular limitation on the negative electrode current collector in the present application, as long as the objectives of the present application can be achieved. For example, the negative electrode current collector may include copper foil, aluminum foil, nickel foil, stainless steel foil, titanium foil, nickel foam, copper foam, a polymer substrate coated with a conductive metal, or the like. The conductive metal includes, but is not limited to, copper, nickel, or titanium, and the material of the polymer substrate includes, but is not limited to, at least one of polyethylene, polypropylene, ethylene propylene copolymer, polyethylene terephthalate, polyethylene naphthalate, or poly(p-phenylene terephthalamide). In the present application, there is no particular limitation on the thickness of the negative electrode current collector and the negative electrode material layer, as long as the objectives of the present application can be achieved. For example, the thickness of the negative electrode current collector is 4 μm to 12 μm, and the thickness of the single-sided negative electrode material layer is 30 μm to 160 μm. In the present application, the negative electrode mixture layer may be disposed on one surface in the thickness direction of the negative electrode current collector or on both surfaces in the thickness direction of the negative electrode current collector. It should be noted that the “surface” herein may be the entire region of the negative electrode current collector or a part of the region of the negative electrode current collector, and the present application has no particular limitation as long as the objectives of the present application can be achieved.

There is no particular limitation on the compacted density of the negative electrode plate in the present application, as long as the objectives of the present application can be achieved. For example, the compacted density of the negative electrode plate may be 1.0 g/cm³ to 1.85 g/cm³. There is no particular limitation on the cold pressing pressure of the negative electrode plate in the present application, as long as the objectives of the present application can be achieved. For example, the cold pressing pressure of the negative electrode plate may be 3 tons to 30 tons.

Optionally, the negative electrode plate may further include a conductive layer, the conductive layer being disposed between the negative electrode current collector and the negative electrode material layer. There is no particular limitation on the composition of the conductive layer in the present application, and it may be a conductive layer commonly used in the art. The conductive layer includes a conductive agent and a binder. There is no particular limitation on the conductive agent and binder in the conductive layer of the present application, and they may be at least one of the above conductive agents and the above binders. There is no particular limitation on the mass ratio of the conductive agent and binder in the conductive layer of the present application, and those skilled in the art may select it according to actual needs as long as the objectives of the present application can be achieved. There is no particular limitation on the thickness of the conductive layer in the present application, as long as the objectives of the present application can be achieved, for example, the thickness of the conductive layer is 1 μm to 10 μm.

### Separator

A separator is generally disposed between the positive electrode and the negative electrode in the present application, and the separator is used to separate the positive electrode plate and the negative electrode plate to prevent internal short circuit of the secondary battery, allowing electrolyte ions to pass freely without affecting the electrochemical charge-discharge process.

There is no particular limitation on the separator in the present application, as long as the objectives of the present application can be achieved. For example, the material of the separator may include, but is not limited to, at least one of polyolefin (PO)-based materials mainly including polyethylene (PE) and polypropylene (PP), polyester (for example, polyethylene terephthalate (PET) film), cellulose, polyimide (PI), polyamide (PA), spandex, or aramid; and the type of the separator may include at least one of woven film, non-woven film, microporous film, composite film, calendered film, or spun film.

In the present application, the separator may include a substrate and a surface treatment layer. The substrate may be a non-woven fabric or composite film having a porous structure, and the material of the substrate may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, a surface treatment layer is disposed on at least one surface of the substrate, and the surface treatment layer may be a polymer layer or an inorganic layer, or a layer formed by mixing a polymer and an inorganic substance. For example, the inorganic layer includes inorganic particles and a binder, and there is no particular limitation on the above inorganic particles in the present application, for example, it may include at least one of alumina, silica, magnesia, titania, hafnia, tin oxide, ceria, nickel oxide, zinc oxide, calcium oxide, zirconia, yttria, silicon carbide, bochmite, aluminum hydroxide, magnesium hydroxide, calcium hydroxide, or barium sulfate. There is no particular limitation on the above binder in the present application, for example, it may be at least one of the aforementioned binders. The polymer layer includes a polymer, and the material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

In the present application, the pore size of the separator is 0.01 μm to 1 μm, and the thickness is 5 μm to 50 μm. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator is within the above range, insulation and mechanical strength can be ensured, and the rate characteristics and energy density of the secondary battery can be ensured.

Another embodiment of the present application provides an electronic apparatus including the secondary battery of some embodiments of the present application. The electronic apparatus includes, but is not limited to, notebook computers, pen-input computers, mobile computers, e-book players, portable telephones, portable fax machines, portable copiers, portable printers, stereo headphones, video recorders, LCD televisions, portable cleaners, portable CD players, mini discs, transceivers, electronic organizers, calculators, memory cards, portable recorders, radios, backup power supplies, motors, automobiles, motorcycles, power-assisted bicycles, bicycles, lighting fixtures, toys, game consoles, clocks, power tools, flashlights, cameras, large-scale household batteries, and lithium-ion capacitors.

### EXAMPLES

Hereinafter, lithium-ion batteries are taken as an example to more specifically illustrate some embodiments of the electrochemical apparatus of the present application by way of examples and comparative examples. Those skilled in the art will understand that the preparation methods described in the present application are only examples, and any other suitable preparation methods are within the scope of the present application. Various tests and evaluations were carried out according to the following methods. In addition, unless otherwise specified, “parts” and “%” are on a mass basis.

### Example 1-1

### (1) Preparation of Positive Electrode

Positive electrode active material Li_{1.08}Ni_{0.57}Co_{0.16}Mn_{0.31}Al_{0.0004}O_{1.998}S_{0.002}, conductive agent conductive carbon black, and polyvinylidene fluoride (PVDF) were mixed in a mass ratio of 95:2:3, N-methylpyrrolidone (NMP) was added, and the mixture was well stirred under the action of a vacuum mixer to obtain a positive electrode slurry with a solid content of 70 wt %. The positive electrode slurry was uniformly applied to one surface of a positive electrode current collector aluminum foil with a thickness of 9 μm, and dried to obtain a positive electrode plate having a single surface coated with a positive electrode mixture layer, with a coating weight on one surface being 12.5 mg/cm². The above steps were repeated on the other surface of the positive electrode current collector aluminum foil to obtain a positive electrode plate having both surfaces coated with the positive electrode mixture layer. Then, the required positive electrode plate was obtained by cold pressing, slitting, cutting, and tab welding.

### (2) Preparation of Non-Aqueous Electrolyte

In a dry argon atmosphere glove box, LiPF₆ was dissolved in a mixed solution of dimethyl carbonate, ethyl methyl carbonate, diethyl carbonate, ethylene carbonate, and propylene carbonate to obtain a non-aqueous electrolyte. Based on the total mass of the non-aqueous electrolyte, the mass percentages of LiPF₆ and each compound are shown in Table 1.

### (3) Preparation of Negative Electrode

Artificial graphite was used as a negative electrode active material, the negative electrode active material, styrene-butadiene rubber (SBR), polyacrylic acid (PAA), carbon nanotubes (CNT), and carboxymethyl cellulose (CMC) were mixed in a mass ratio of 95.8:2.4:0.5:0.5:0.8, then deionized water was added as a solvent and stirred well to prepare a negative electrode slurry with a solid content of 45 wt %. The negative electrode slurry was uniformly applied to one surface of a negative electrode current collector copper foil with a thickness of 6 μm, and dried to obtain a negative electrode plate having a single surface coated with a negative electrode mixture layer, with a coating weight on one surface being 7.5 mg/cm². The above steps were repeated on the other surface of the negative electrode current collector copper foil to obtain a negative electrode plate having both surfaces coated with the negative electrode mixture layers. Then, the required negative electrode plate was obtained by cold pressing, slitting, cutting, and tab welding.

(4) Preparation of separator: a porous polyethylene film with a thickness of 15 μm was used as the separator.

(5) Preparation of lithium-ion battery: The positive electrode plate, negative electrode plate, and separator were stacked in order, with the separator positioned between the positive electrode plate and the negative electrode plate for isolation, and wound to obtain an electrode assembly. The electrode assembly was placed in a packaging bag, and an electrolyte was injected and encapsulated. After standing, formation, degassing, edge cutting, capacity testing, and other processes, a lithium-ion battery was obtained.

### <Test Methods>

### 1. 4C Rate Discharge Test

At 25° C., the formed lithium-ion battery was charged at a constant current of 0.2C to 4.35 V, then charged at a constant voltage until the current was less than or equal to 0.05C, then left standing for 30 minutes, and then discharged at a constant current of 0.2C to 3.0 V to test the 0.2C rate discharge capacity of the lithium-ion battery at 25° C. At 25° C., the lithium-ion battery was charged at a constant current of 0.2C to 4.35 V, then charged at a constant voltage until the current was less than or equal to 0.05C, and left standing for 60 minutes; and discharged at a constant current of 4C rate to 3.0 V to test the 4C rate discharge capacity of the lithium-ion battery at 25° C.

4C rate discharge capacity retention rate % of the lithium-ion secondary battery at 25° C.=4C rate discharge capacity at 25° C./0.2C rate discharge capacity at 25° C.×100%.

### (2) High-Temperature Storage Performance Test

At 25° C., the formed lithium-ion battery was charged at a constant current of 0.5C to a voltage of 4.35 V, then charged at a constant current of 1C to 4.35 V, and then charged at a constant voltage until the current was 0.05C, and the battery thickness d1 at this time was recorded. Then the lithium-ion battery was placed in a high-temperature furnace at a temperature of 80° C. for 48 hours, and after the cell was taken out, the battery thickness d2 at this time was immediately tested.

$$High - temperature storage thickness swelling rate \% = ( d 2 - d 1 ) / d 1 \times 100 \% .$$

### 3. Overdischarge Storage Gas Production Thickness Change

At 25° C., the formed lithium-ion battery was charged at a constant current of 0.5C to a voltage of 4.35 V, then charged at a constant current of 1C to 4.35 V, then charged at a constant voltage until the current was 0.05C, then discharged at 0.2C to 3.0 V, left standing for 15 min, then discharged at 0.02C to 3.0 V, and the battery thickness D1 at this time was recorded. Then the lithium-ion battery was placed in a high-temperature furnace at a temperature of 60° C. for 30 days, and after the cell was taken out, the battery thickness D2 at this time was immediately tested.

High-temperature storage thickness swelling rate %=(D2−D1)/D1×100%.

The lithium-ion batteries of the following examples or comparative examples differed from the batteries in Example 1-1 only in that the mass percentage of each substance in the electrolyte was adjusted according to Table 1, and if there was any remainder, the remainder was propyl acetate. The performance test results of the lithium-ion batteries of each example and comparative example are shown in Table 1 below.

TABLE 1

| | | | | | | | | | | | | | Rate | High- |
|---|---|---|---|---|---|---|---|---|---|---|---|---|---|---|
| | | | | | | | | | | | | | discharge | temperature |
| | | | | | | | | | | | | | capacity | storage gas |
| | | | | (M4 + | (M2 + | | | | | | | | retention | production |
| | M1 | M2 | M3 | M5) | M3) | | M4 | M5 | M6 | M7 | (M6 + M7) | | rate | thickness |
| Group | (%) | (%) | (%) | (%) | (%) | Relation 1 | (%) | (%) | (%) | (%) | (%) | Relation 2 | (%) | (%) |
| Example 1-1 | 0.001 | 22 | 27.999 | 35 | 49.999 | 1.28 | 20 | 15 | 15 | 0 | 15 | 3.84 | 75.2 | 32.5 |
| Example 1-2 | 0.005 | 22 | 27.995 | 35 | 49.995 | 1.30 | 20 | 15 | 15 | 0 | 15 | 3.84 | 75.2 | 29.6 |
| Example 1-3 | 0.05 | 22 | 27.95 | 35 | 49.95 | 1.50 | 20 | 15 | 15 | 0 | 15 | 3.84 | 75.3 | 28.3 |
| Example 1-4 | 0.1 | 22 | 27.9 | 35 | 49.9 | 1.72 | 20 | 15 | 15 | 0 | 15 | 3.84 | 75.2 | 29.8 |
| Example 1-5 | 0.002 | 20 | 29.998 | 35 | 49.998 | 1.51 | 20 | 15 | 15 | 0 | 15 | 3.84 | 75.3 | 30.1 |
| Example 1-6 | 0.002 | 28 | 21.998 | 35 | 49.998 | 0.79 | 20 | 15 | 15 | 0 | 15 | 3.84 | 76.1 | 30.5 |
| Example 1-7 | 0.002 | 44 | 4.998 | 35 | 48.998 | 0.12 | 20 | 15 | 15 | 0 | 15 | 3.84 | 75.2 | 32.8 |
| Example 1-8 | 0.002 | 59.998 | 6 | 21 | 65.998 | 0.10 | 15 | 6 | 9 | 0 | 9 | 3.93 | 75.1 | 33.2 |
| Example 1-9 | 0.002 | 15 | 34.998 | 35 | 49.998 | 2.35 | 20 | 15 | 15 | 0 | 15 | 3.84 | 75.0 | 33.3 |
| Example 1-10 | 0.1 | 15 | 34.9 | 35 | 49.9 | 2.99 | 20 | 15 | 15 | 0 | 15 | 3.84 | 75.1 | 33.1 |
| Example 1-11 | 0.002 | 25 | 34.998 | 20 | 59.998 | 1.41 | 10 | 10 | 10 | 0 | 10 | 3.25 | 75.5 | 32.7 |
| Example 1-12 | 0.002 | 25 | 29.998 | 25 | 54.998 | 1.21 | 15 | 10 | 10 | 0) | 10 | 4.14 | 76.8 | 31.3 |
| Example 1-13 | 0.002 | 25 | 32.498 | 32 | 57.498 | 1.31 | 12 | 20 | 10.5 | 0 | 10.5 | 4.85 | 76.5 | 31.2 |
| Example 1-14 | 0.002 | 25 | 19.998 | 40 | 44.998 | 0.81 | 20 | 20 | 15 | 0 | 15 | 4.34 | 76.6 | 31.5 |
| Example 1-15 | 0.002 | 23 | 31.998 | 30 | 54.998 | 1.40 | 25 | 5 | 15 | 0 | 15 | 3.44 | 77.7 | 30.9 |
| Example 1-16 | 0.002 | 25 | 24.998 | 30 | 49.998 | 1.01 | 25 | 5 | 20 | 0 | 20 | 2.58 | 77.9 | 31.0 |
| Example 1-17 | 0.001 | 30 | 10.999 | 34 | 40.999 | 0.37 | 25 | 9 | 25 | 0 | 25 | 2.30 | 80.0 | 31.2 |
| Example 1-18 | 0.001 | 50 | 14.999 | 20 | 64.999 | 0.30 | 10 | 10 | 15 | 0 | 15 | 2.17 | 80.2 | 31.6 |
| Example 1-19 | 0.005 | 22 | 17.995 | 35 | 39.995 | 0.84 | 20 | 15 | 10 | 7 | 17 | 3.67 | 80.5 | 30.5 |
| Example 1-20 | 0.005 | 22 | 27.995 | 35 | 49.995 | 1.30 | 20 | 15 | 2.5 | 12.5 | 15 | 4.55 | 80.3 | 30.1 |
| Example 1-21 | 0.005 | 22 | 25.495 | 35 | 47.495 | 1.18 | 20 | 15 | 5 | 12.5 | 17.5 | 3.80 | 80.6 | 30.2 |
| Example 1-22 | 0.005 | 22 | 22.995 | 35 | 44.995 | 1.07 | 20 | 15 | 15 | 5 | 20 | 3.02 | 80.4 | 30.4 |
| Example 1-23 | 0.005 | 22 | 17.995 | 35 | 39.995 | 0.84 | 20 | 15 | 25 | 0 | 25 | 2.30 | 79.8 | 30.8 |
| Comparative | 0 | 22 | 37 | 31 | 59 | 1.68 | 21 | 10 | 10 | 0 | 10 | 5.19 | 66.1 | 55.1 |
| Example 1 | | | | | | | | | | | | | | |
| Comparative | 0.15 | 22 | 36.85 | 31 | 58.85 | 2.36 | 21 | 10 | 10 | 0 | 10 | 5.19 | 66.0 | 58.3 |
| Example 2 | | | | | | | | | | | | | | |
| Comparative | 0.002 | 15 | 43.998 | 31 | 58.998 | 2.95 | 21 | 10 | 10 | 0 | 10 | 5.19 | 65.8 | 52.0 |
| Example 3 | | | | | | | | | | | | | | |
| Comparative | 0.002 | 55 | 3.998 | 31 | 58.998 | 0.08 | 21 | 10 | 10 | 0 | 10 | 5.19 | 69.2 | 60.5 |
| Example 4 | | | | | | | | | | | | | | |
| Comparative | 0.002 | 22 | 52.998 | 15 | 74.998 | 2.42 | 5 | 10 | 10 | 0 | 10 | 2.37 | 62.8 | 53.7 |
| Example 5 | | | | | | | | | | | | | | |
| Comparative | 0.002 | 22 | 22.998 | 45 | 44.998 | 1.05 | 20 | 25 | 10 | 0 | 10 | 7.25 | 65.5 | 51.9 |
| Example 6 | | | | | | | | | | | | | | |
| Comparative | 0.1 | 14 | 34.9 | 35 | 48.9 | 3.21 | 20 | 15 | 15 | 0 | 15 | 3.84 | 65.5 | 52.6 |
| Example 7 | | | | | | | | | | | | | | |
| Comparative | 0.1 | 62 | 5.5 | 20 | 67.5 | 0.25 | 10 | 10 | 10 | 0 | 10 | 3.25 | 69.4 | 60.8 |
| Example 8 | | | | | | | | | | | | | | |

In the above table:

Relation 1=(100M₁+M₃)/M₂, with the calculation result rounded to 2 decimal places.

Relation 2=(M₄/86.06+M₅/102.09)/(M₆/151.91+M₇/187.07), with the calculation result rounded to 2 decimal places.

As can be seen from Table 1, when the lithium-ion batteries prepared in the examples of the present application have the mass percentage M₁% of dimethyl carbonate in the electrolyte satisfying 0.001≤M₁≤0.1, the mass percentage M₂% of ethyl methyl carbonate satisfying 15≤M₂≤60, the mass percentage M₃% of diethyl carbonate satisfying 5≤M₃≤35, and the mass percentage M₄% of ethylene carbonate and the mass percentage M₅% of propylene carbonate satisfying 20≤M₄+M₅≤40, the lithium-ion batteries have better rate discharge capacity retention rate and lower high-temperature storage gas production thickness change rate.

In particular, when 20≤M₂≤50 is satisfied, the lithium-ion batteries have better rate discharge capacity retention rate and lower high-temperature storage gas production thickness change rate. In particular, when 40≤M₂+M₃≤66 is satisfied, the lithium-ion batteries have better rate discharge capacity retention rate and lower high-temperature storage gas production thickness change rate. In particular, when 0.1≤(100M₁+M₃)/M₂≤3 is satisfied, the lithium-ion batteries have better rate discharge capacity retention rate and lower high-temperature storage gas production thickness change rate.

The lithium-ion batteries of the following Example 2-1 to Example 2-23 differed from the batteries in Example 1-21 only in that the types and mass percentages of the compounds in the electrolyte were adjusted according to Table 2, and if there was any remainder, the remainder was propyl acetate. The mass percentage of nickel element in the positive electrode mixture layer was adjusted according to Table 2. The performance test results of the lithium-ion batteries of each example are shown in Table 2 below.

TABLE 2

| | | | | | | | | High- | |
|---|---|---|---|---|---|---|---|---|---|
| | | | | | | | Rate | temperature | Overdischarge |
| | | | | | | | discharge | storage | gas production |
| | | Compound | | Compound | | | capacity | thickness | thickness |
| | E | of formula | a | of formula | | | retention | change rate | change rate |
| Group | (%) | I | (%) | II | b (%) | n (%) | rate (%) | (%) | (%) |
| Example 1-21 | 0 | / | 0 | / | 0 | 33.64 | 80.5 | 30.5 | 48.9 |
| Example 2-1 | 0.001 | / | 0 | / | 0 | 33.64 | 81.1 | 24.5 | 40.2 |
| Example 2-2 | 0.01 | / | 0 | / | 0 | 33.64 | 81.3 | 23.8 | 38.8 |
| Example 2-3 | 0.025 | / | 0 | / | 0 | 33.64 | 81.4 | 23.1 | 38.5 |
| Example 2-4 | 0.05 | / | 0 | / | 0 | 33.64 | 81.5 | 22.8 | 38.1 |
| Example 2-5 | 0 | Compound | 0.2 | / | 0 | 33.64 | 83.3 | 25.4 | 35.5 |
| | | I-1 | | | | | | | |
| Example 2-6 | 0 | Compound | 0.2 | / | 0 | 33.64 | 83.2 | 25.2 | 35.6 |
| | | I-3 | | | | | | | |
| Example 2-7 | 0 | Compound | 0.2 | / | 0 | 33.64 | 82.8 | 25.0 | 35.3 |
| | | I-6 | | | | | | | |
| Example 2-8 | 0 | Compound | 0.01 | / | 0 | 33.64 | 82.5 | 24.9 | 35.9 |
| | | I-1 | | | | | | | |
| Example 2-9 | 0 | Compound | 0.05 | / | 0 | 33.64 | 82.9 | 25.1 | 35.8 |
| | | I-1 | | | | | | | |
| Example 2-10 | 0 | Compound | 0.5 | / | 0 | 33.64 | 84.0 | 25.8 | 35.1 |
| | | I-1 | | | | | | | |
| Example 2-11 | 0 | Compound | 1 | / | 0 | 33.64 | 84.4 | 26.0 | 34.7 |
| | | I-1 | | | | | | | |
| Example 2-12 | 0 | / | 0 | Compound | 2.5 | 33.64 | 78.7 | 18.9 | 37.1 |
| | | | | II-3 | | | | | |
| Example 2-13 | 0 | / | 0 | Compound | 2.5 | 33.64 | 79.0 | 19.0 | 37.3 |
| | | | | II-5 | | | | | |
| Example 2-14 | 0 | / | 0 | Compound | 2.5 | 33.64 | 78.8 | 18.8 | 36.8 |
| | | | | II-8 | | | | | |
| Example 2-15 | 0 | / | 0 | Compound | 2 | 33.64 | 78.6 | 19.3 | 37.2 |
| | | | | II-3 | | | | | |
| Example 2-16 | 0 | / | 0 | Compound | 3 | 33.64 | 78.8 | 18.7 | 37.0 |
| | | | | II-3 | | | | | |
| Example 2-17 | 0 | / | 0 | Compound | 4 | 33.64 | 79.1 | 18.2 | 36.8 |
| | | | | II-3 | | | | | |
| Example 2-18 | 0 | / | 0 | / | 0 | 33.01 | 79.6 | 28.4 | 49.1 |
| Example 2-19 | 0 | / | 0 | / | 0 | 41.73 | 81.0 | 30.9 | 48.6 |
| Example 2-20 | 0 | / | 0 | / | 0 | 56.02 | 81.8 | 31.2 | 48.5 |
| Example 2-21 | 0.01 | Compound | 0.4 | Compound | 3 | 42.22 | 85.7 | 15.2 | 12.8 |
| | | I-1 | | II-3 | | | | | |
| Example 2-22 | 0.01 | Compound | 0.5 | Compound | 3 | 44.51 | 85.9 | 15.3 | 12.5 |
| | | I-1 | | II-3 | | | | | |
| Example 2-23 | 0.01 | Compound | 0.6 | Compound | 3 | 44.98 | 86.0 | 15.5 | 12.1 |
| | | I-1 | | II-3 | | | | | |

As can be seen from Table 2, when the electrolyte of the lithium-ion batteries prepared in the examples of the present application further includes vinylene carbonate and its mass percentage satisfies 0.001≤E≤0.05, the lithium-ion batteries have better rate discharge capacity retention rate, lower high-temperature storage gas production thickness change rate, and lower overdischarge gas production thickness change rate. When the electrolyte further includes a compound of formula I and its mass percentage satisfies 0.01≤a≤1, the lithium-ion batteries have better rate discharge capacity retention rate, lower high-temperature storage gas production thickness change rate, and lower overdischarge gas production thickness change rate. When the electrolyte further includes a compound of formula II and its mass percentage satisfies 2≤b≤4, the lithium-ion batteries have better rate discharge capacity retention rate, lower high-temperature storage gas production thickness change rate, and lower overdischarge gas production thickness change rate.

The above are only preferred embodiments of the present application and are not intended to limit the present application. Any modifications, equivalent replacements, and improvements made within the spirit and principles of the present application shall be included within the protection scope of the present application.

What is claimed is:

1. Anon-aqueous electrolyte, wherein the non-aqueous electrolyte comprises chain carbonates and cyclic carbonates; the chain carbonates comprise dimethyl carbonate, ethyl methyl carbonate, and diethyl carbonate; and the cyclic carbonates comprise at least one of ethylene carbonate or propylene carbonate; and based on a total mass of the non-aqueous electrolyte,
a mass percentage of dimethyl carbonate is M₁%, wherein 0.001≤M₁≤0.1;
a mass percentage of ethyl methyl carbonate is M₂%, wherein 15≤M₂≤60;
a mass percentage of diethyl carbonate is M₃%, wherein 5≤M₃≤35; and
a mass percentage of ethylene carbonate is M₄%, a mass percentage of propylene carbonate is M₅%, and 20≤M₄+M₅≤40.

2. The non-aqueous electrolyte according to claim 1, wherein the non-aqueous electrolyte satisfies at least one of the following conditions:
$$20 \leq {M}_{2} \leq 50 ; \qquad ( 1 )$$
$$40 \leq {M}_{2} + {M}_{3} \leq 66 ; or \qquad ( 2 )$$
$$0.1 \leq \frac{100 \times {M}_{1} + {M}_{3}}{{M}_{2}} \leq 3. \qquad ( 3 )$$

3. The non-aqueous electrolyte according to claim 1, wherein the non-aqueous electrolyte further comprises at least one of lithium hexafluorophosphate or lithium bis(fluorosulfonyl)imide;
based on the total mass of the non-aqueous electrolyte, a mass percentage of lithium hexafluorophosphate is M₆%, and a mass percentage of lithium bis(fluorosulfonyl)imide is M₇%, wherein 2.5≤M₆≤25 and 15≤M₆+M₇≤25.

4. The non-aqueous electrolyte according to claim 3, wherein the non-aqueous electrolyte satisfies:
$$2.17 \leq \frac{\frac{{M}_{4}}{86.06} + \frac{{M}_{5}}{102.09}}{\frac{{M}_{6}}{151.91} + \frac{{M}_{7}}{187.07}} \leq 4.85 .$$

5. The non-aqueous electrolyte according to claim 1, wherein the non-aqueous electrolyte further comprises vinylene carbonate; and
based on the total mass of the non-aqueous electrolyte, a mass percentage of vinylene carbonate is E %, wherein 0.001≤E≤0.05.

6. The non-aqueous electrolyte according to claim 1, wherein the non-aqueous electrolyte further comprises a compound of formula I: 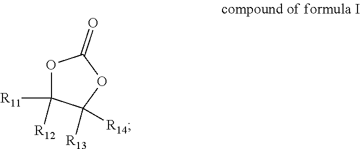
wherein each of R₁₁, R₁₂, R₁₃ and R₁₄ is independently selected from H, F, C₁ to C₃ alkyl or fluorine-substituted C₁ to C₃ alkyl, and at least one of R₁₁, R₁₂, R₁₃ and R₁₄ is a fluorine atom; and
based on the total mass of the non-aqueous electrolyte, a mass percentage of the compound of formula I is a %, wherein 0.01≤a≤1.

7. The non-aqueous electrolyte according to claim 6, wherein the compound of formula I comprises at least one of the following compounds:

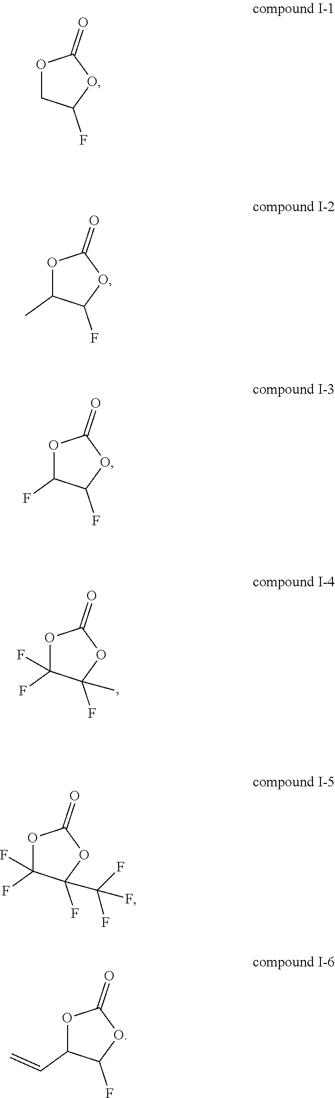

8. The non-aqueous electrolyte according to claim 1, wherein the non-aqueous electrolyte further comprises a compound of formula II: 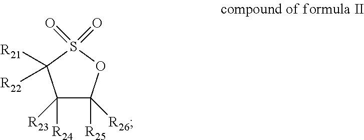
wherein each of R₂₁, R₂₂, R₂₃, R₂₄, R₂₅ and R₂₆ is independently selected from H, F, C₁ to C₃ alkyl or fluorine-substituted C₁ to C₃ alkyl; and
based on the total mass of the non-aqueous electrolyte, a mass percentage of the compound of formula II is b %, wherein 2≤b≤4.

9. The non-aqueous electrolyte according to claim 8, wherein the compound of formula II comprises at least one of the following compounds:

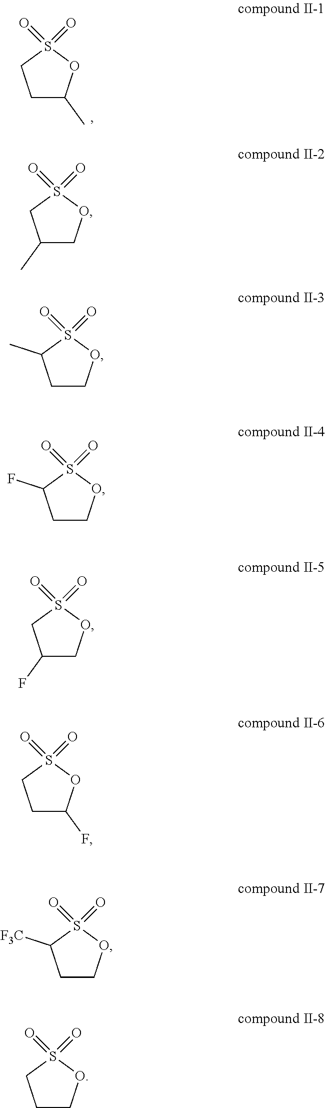

10. An electrochemical apparatus, comprising a positive electrode plate, a negative electrode plate, and a non-aqueous electrolyte; wherein
the non-aqueous electrolyte comprises chain carbonates and cyclic carbonates; the chain carbonates comprise dimethyl carbonate, ethyl methyl carbonate, and diethyl carbonate, and the cyclic carbonates comprise at least one of ethylene carbonate or propylene carbonate; and based on a total mass of the non-aqueous electrolyte,
a mass percentage of dimethyl carbonate is M₁%, wherein 0.001≤M₁≤0.1;
a mass percentage of ethyl methyl carbonate is M₂%, wherein 15≤M₂≤60;
a mass percentage of diethyl carbonate is M₃%, wherein 5≤M₃≤35; and
a mass percentage of ethylene carbonate is M₄%, a mass percentage of propylene carbonate is M₅%, and 20≤M₄+M₅≤40.

11. The electrochemical apparatus according to claim 10, wherein the non-aqueous electrolyte satisfies at least one of the following conditions:
$$20 \leq {M}_{2} \leq 50 ; \qquad ( 1 )$$
$$40 \leq {M}_{2} + {M}_{3} \leq 66 ; or \qquad ( 2 )$$
$$0.1 \leq \frac{100 \times {M}_{1} + {M}_{3}}{{M}_{2}} \leq 3. \qquad ( 3 )$$

12. The electrochemical apparatus according to claim 10, wherein the non-aqueous electrolyte further comprises at least one of lithium hexafluorophosphate or lithium bis(fluorosulfonyl)imide;
based on the total mass of the non-aqueous electrolyte, a mass percentage of lithium hexafluorophosphate is M₆%, and a mass percentage of lithium bis(fluorosulfonyl)imide is M₇%, wherein 2.5≤M₆≤25 and 15≤M₆+M₇≤25.

13. The electrochemical apparatus according to claim 12, wherein the non-aqueous electrolyte satisfies:
$$2.17 \frac{\frac{{M}_{4}}{86.06} + \frac{{M}_{5}}{102.09}}{\frac{{M}_{6}}{151.91} + \frac{{M}_{7}}{187.07}} \leq 4.85 .$$

14. The electrochemical apparatus according to claim 10, wherein the non-aqueous electrolyte further comprises vinylene carbonate; and
based on the total mass of the non-aqueous electrolyte, a mass percentage of vinylene carbonate is E %, wherein 0.001≤E≤0.05.

15. The electrochemical apparatus according to claim 10, wherein the non-aqueous electrolyte further comprises a compound of formula I: 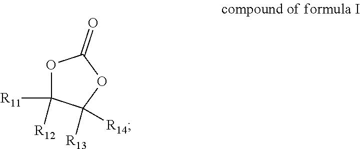
wherein each of R₁₁, R₁₂, R₁₃ and R₁₄ is independently selected from H, F, C₁ to C₃ alkyl or fluorine-substituted C₁ to C₃ alkyl, and at least one of R₁₁, R₁₂, R₁₃ and R₁₄ is a fluorine atom; and
based on the total mass of the non-aqueous electrolyte, a mass percentage of the compound of formula I is a %, wherein 0.01≤a≤1.

16. The electrochemical apparatus according to claim 15, wherein the compound of formula I comprises at least one of the following compounds:

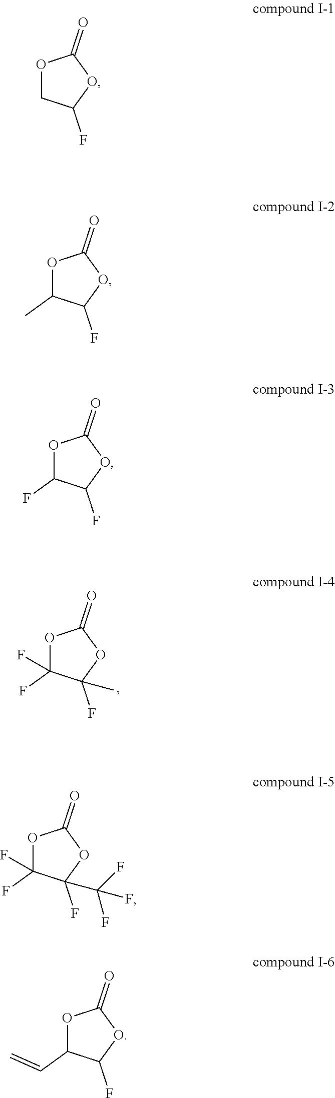

17. The electrochemical apparatus according to claim 10, wherein the non-aqueous electrolyte further comprises a compound of formula II: 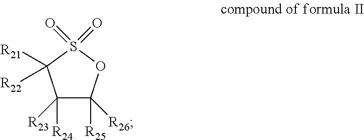
wherein each of R₂₁, R₂₂, R₂₃, R₂₄, R₂₅ and R₂₆ is independently selected from H, F, C₁ to C₃ alkyl or fluorine-substituted C₁ to C₃ alkyl; and
based on the total mass of the non-aqueous electrolyte, a mass percentage of the compound of formula II is b %, wherein 2≤b≤4.

18. The electrochemical apparatus according to claim 17, wherein the compound of formula II comprises at least one of the following compounds:

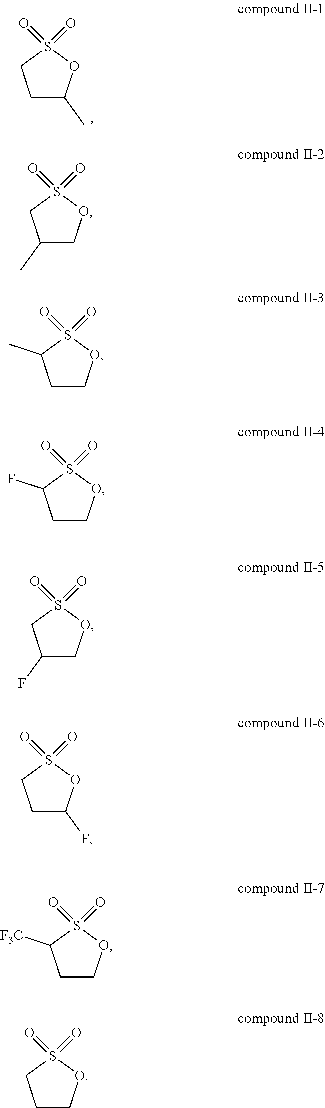

19. The electrochemical apparatus according to claim 10, wherein the positive electrode plate comprises a positive electrode current collector and a positive electrode mixture layer disposed on at least one surface of the positive electrode current collector, and the negative electrode plate comprises a negative electrode current collector and a negative electrode mixture layer disposed on at least one surface of the negative electrode current collector; and
a positive electrode active material in the positive electrode mixture layer comprises LiₓNi_{y}M_{1-y}O_{2-z}A_{z}, wherein 0.98≤x≤1.1, 0.53≤y≤0.95, and 0≤z≤0.05;
and based on a total mass of the positive electrode mixture layer, a mass percentage of nickel element is n %, satisfying 33≤n≤56;
wherein element M is at least one selected from aluminum, magnesium, manganese, cobalt, iron, chromium, vanadium, titanium, copper, calcium, zinc, zirconium, niobium, molybdenum, strontium, antimony, tungsten, or bismuth; and
element A is at least one selected from fluorine, phosphorus, sulfur, boron, silicon, or chlorine.

20. An electronic apparatus comprising an electrochemical apparatus, the electrochemical apparatus comprises a positive electrode plate, a negative electrode plate, and a non-aqueous electrolyte; wherein the non-aqueous electrolyte comprises chain carbonates and cyclic carbonates; the chain carbonates comprise dimethyl carbonate, ethyl methyl carbonate, and diethyl carbonate, and the cyclic carbonates comprise at least one of ethylene carbonate or propylene carbonate; and based on a total mass of the non-aqueous electrolyte,
a mass percentage of dimethyl carbonate is M₁%, wherein 0.001≤M₁≤0.1;
a mass percentage of ethyl methyl carbonate is M₂%, wherein 15≤M₂≤60;
a mass percentage of diethyl carbonate is M₃%, wherein 5≤M₃≤35; and
a mass percentage of ethylene carbonate is M₄%, a mass percentage of propylene carbonate is M₅%, and 20≤M₄+M₅ ≤40.
